(19) United States
(12) Patent Application Publication
(10) Pub. No.: US 2019/0380543 A1
(43) Pub. Date: Dec. 19, 2019

(54) MODULAR CUTTING BOARD AND ACCESSORIES

(71) Applicant: Prateek N. Bhargava, Edison, NJ (US)

(72) Inventor: Prateek N. Bhargava, Edison, NJ (US)

(21) Appl. No.: 16/009,648

(22) Filed: Jun. 15, 2018

(51) Int. Cl. A47J 47/00; B26B 27/00

(52) U.S. Cl. CPC A47J 47/005; B26B 27/00

(57) ABSTRACT

In one aspect of the present disclosure, a cutting board is disclosed that includes a body having a first attachment structure and at least one accessory that is configured for releasable connection to the body. The at least one accessory includes a second attachment structure that is positioned in correspondence with the first attachment structure to facilitate connection and disconnection of the at least one accessory and the body.

### TECHNICAL FIELD

The present disclosure relates generally to cutting boards (e.g., for use in food preparation), and more particularly, to a cutting board that includes one or more attachable and detachable accessories.

### BACKGROUND

The cutting board is a ubiquitous kitchen tool that finds a place in the preparation of most meals. Typically, a user will cut or prepare foods on the cutting board using one or more tools (e.g., a knife, a grater, a peeler, etc.) and then transfer the food from the cutting board into a separate container, such as a tray, bowl, etc., for additional preparation (e.g., seasoning) or for storage. It is also common during food preparation to use multiple cutting boards to avoid contamination. For example, one cutting board may be used to prepare vegetables while another cutting board may be used to prepare raw meat(s). This process can often be cumbersome in that it requires the collection and arrangement of the required tools and containers, which may be stored in different locations.

To simplify the preparation process, the present disclosure describes a unique, modular cutting board that itself includes the several requisite tools and containers to reduce the overall time required for meal preparation.

### SUMMARY

In one aspect of the present disclosure, a cutting board is disclosed that includes a body having a first attachment structure and at least one accessory that is configured for releasable connection to the body. The at least one accessory includes a second attachment structure that is positioned in correspondence with the first attachment structure to facilitate connection and disconnection of the at least one accessory and the body.

In certain implementations, the first attachment structure may be associated with a perimeter of the body and the second attachment structure may be associated with a perimeter of the at least one accessory.

In certain implementations, the first attachment structure may be configured and dimensioned for positioning within the second attachment structure.

In certain implementations, the first and second attachment structures may include magnets.

In certain implementations, the magnets may be secured to the perimeters of the body and the at least one accessory.

In certain implementations, the magnets may be embedded within the perimeters of the body and the at least one accessory.

In certain implementations, the at least one accessory may include a first accessory and a second accessory. In such implementations, the first and second accessories may be independently connectable to the body and independently disconnectable from the body.

In certain implementations, the body may define a main body portion and a handle that extends from the main body portion.

In certain implementations, the handle may extend from the main body portion such that the handle is positionable between the first and second accessories.

In certain implementations, the body and the at least one accessory may include corresponding engagement portions defining beveled surfaces that are configured and dimensioned for mating engagement.

In certain implementations, the engagement portions may include corresponding concave and convex configurations.

In certain implementations, the cutting board may further include a cutting element connected to the body.

In certain implementations, the cutting element may be connected to the body such that the cutting element is movable in one or more degrees of freedom. For example, the cutting element may be movable along a first axis extending in generally orthogonal relation to a top surface of the cutting board and along a second axis extending in generally parallel relation to the top surface of the cutting board.

In certain implementations, the body may include a removable panel.

In certain implementations, the body may define a recess that is configured and dimensioned to receive the panel such that the panel is coplanar with a top surface of the body.

In another aspect of the present disclosure, a cutting board is disclosed that includes at least one magnetically connectable accessory.

In certain implementations, the at least one magnetically connectable accessory may include discrete first and second accessories.

In certain implementations, the cutting board may define a handle that extends between the first and second accessories when the first and second accessories are connected to the cutting board.

In another aspect of the present disclosure, a method is disclosed for manufacturing a cutting board that includes at least one removable accessory. The method includes: (i) forming at least one recess in a body of the cutting board that is configured and dimensioned to receive the at least one accessory; (ii) connecting a first magnet to the body of the cutting board such that the first magnet is oriented in transverse relation to a cutting surface of the cutting board; and (iii) connecting a second magnet to the at least one accessory such that the first and second magnets are positioned in correspondence when the at least one accessory is situated within the recess to permit connection and disconnection of the at least one accessory and the body.

In another aspect of the present disclosure, a cutting board is disclosed that includes a body and at least one accessory that is configured for releasable connection to the body. The body includes a first magnet, and the at least one accessory includes a second magnet that is positioned in correspondence with the first magnet to facilitate connection and disconnection of the at least one accessory and the body.

In certain implementations, the at least one accessory may include first and second accessories. In such implementations, the first and second accessories may be independently connectable to the body and independently disconnectable from the body.

In certain implementations, the body may define a main body portion, and a handle extending from the main body portion. In such implementations, the handle may extend from the main body portion such that the handle is positionable between the first and second accessories.

In certain implementations, the body may include a top (cutting) surface and a bottom surface extending in generally parallel relation to the top surface, as well as a plurality of transverse walls connecting the top and bottom surfaces.

In certain implementations, the first magnet may be secured to one of the plurality of transverse walls of the body. For example, the first magnet may be embedded within the transverse wall such that an outer surface of the first magnet is coplanar with the transverse wall.

In certain implementations, the at least one accessory may be configured as a tray defining a cavity, as a grater, or as a peeler.

In certain implementations, the cutting board may further include a cutting element (e.g., a knife) connected to the body.

In certain implementations, the cutting element may be connected to the body such that the cutting element is movable through a first plane and a second plane transverse in relation to the first plane.

In certain implementations, the first plane may extend in orthogonal relation to a top (cutting) surface of the cutting board.

In certain implementations, the second plane may extend in parallel relation to the top (cutting) surface such that the first and second planes are orthogonal in relation to one another.

In certain implementations, the body may include a removable panel.

In certain implementations, the body may define a recess that is configured and dimensioned to receive the panel such that the panel is coplanar with the top (cutting) surface of the body.

In another aspect of the present disclosure, a cutting board kit is disclosed that includes a cutting board having a first attachment structure, and first and second accessories that are releasably connectable to the cutting board. Each of first and second accessories includes a second attachment structure that is positioned in correspondence with the first attachment structure to facilitate connection and disconnection of the first and second accessories to and from the cutting board.

In certain implementations of the kit, the first attachment structure may be associated with a perimeter of the cutting board and the second attachment structure may be associated with perimeters of the first and second accessories.

In certain implementations of the kit, the first attachment structure may be configured and dimensioned for positioning within the second attachment structure.

In certain implementations of the kit, the first and second attachment structures may include magnets.

In certain implementations of the kit, the magnets may be secured to the perimeters of the cutting board and the at least one accessory.

In certain implementations of the kit, the magnets may be embedded within the perimeters of the cutting board and the first and second accessories.

In certain implementations of the kit, the first and second accessories may be independently connectable to the cutting board and independently disconnectable from the cutting board.

In certain implementations of the kit, the cutting board may define a main body portion and a handle extending from the main body portion.

In certain implementations of the kit, the handle may extend from the main body portion such that the handle is positionable between the first and second accessories.

In certain implementations of the kit, the cutting board may include a first engagement portion, and the first and second accessories may each include a corresponding second engagement portion. In such implementations, the first and second engagement portions may define beveled surfaces that are configured and dimensioned for mating engagement.

In certain implementations of the kit, the engagement portions may include corresponding concave and convex configurations.

In certain implementations, the kit may further include at least one cutting element, and a retainer that connects the at least one cutting element to the cutting board.

In certain implementations of the kit, the retainer may be configured to allow for movement of the at least one cutting element in at least one degree of freedom. For example, the at least one cutting element may be movable along a first axis extending in generally orthogonal relation to a top surface of the cutting board, and along a second axis extending in generally parallel relation to the top surface of the cutting board.

In certain implementations of the kit, the at least one cutting element may include a first cutting element having a single blade.

In certain implementations of the kit, the at least one cutting element may include a handle that is pivotably connected to the blade.

In certain implementations of the kit, the at least one cutting element may further include a second cutting element having multiple blades.

In certain implementations of the kit, the at least one cutting element may further include a third cutting element configured as a mesh cutter.

In certain implementations of the kit, the at least one cutting element may further include a fourth cutting element configured as a slicer.

In certain implementations of the kit, the at least one cutting element may be releasably connectable to the retainer.

In certain implementations of the kit, the at least one cutting element may include a plurality of interchangeable knives that are each configured and dimensioned for releasable connection to the retainer.

In certain implementations of the kit, the cutting board may define a recess that is configured and dimensioned to removably receive at least one panel.

In certain implementations, the kit may further include first and second panels that are each removably positionable within the recess in the cutting board.

In certain implementations of the kit, the first and second accessories may each be configured as a tray defining a cavity.

In certain implementations, the kit may further include a third accessory (e.g., a grater) that is releasably connectable to the cutting board. In such implementations, the third accessory may include a second attachment structure positioned in correspondence with the first attachment structure to facilitate connection and disconnection of the third accessory to and from the cutting board.

In certain implementations, the kit may further include a fourth accessory (e.g., a peeler) that is releasably connectable to the cutting board. In such implementations, the fourth accessory may include a second attachment structure positioned in correspondence with the first attachment structure to facilitate connection and disconnection of the fourth accessory to the cutting board.

### BRIEF DESCRIPTION OF THE DRAWINGS

FIG. 1 is a top, perspective view of one embodiment of a cutting board including a series of removable modular accessories in accordance with the principles of the present disclosure;

FIG. 2 is a top, perspective view of an alternate embodiment of the cutting board;

FIG. 3 is a top, perspective view of an alternate embodiment of the cutting board;

FIG. 4 is a bottom, perspective view of the cutting board according to one embodiment;

FIG. 5 is a partial, perspective view of the cutting board and one of the accessories illustrating corresponding attachment structures to facilitate connection and disconnection of the accessory;

FIG. 6 is a partial, perspective view of another embodiment of the attachment structures provided on the cutting board and the accessories;

FIG. 7 is a partial, perspective view of another embodiment of the attachment structures provided on the cutting board and the accessories;

FIG. 8 is a partial, perspective view of another embodiment of the attachment structures provided on the cutting board and the accessories;

FIG. 9 is a partial, side view showing connection of the cutting board and one of the accessories in accordance with one embodiment of the disclosure;

FIG. 10 is a partial, side view showing connection of the cutting board and one of the accessories in accordance with another embodiment of the disclosure;

FIG. 11 is a top, perspective view of a scraper for use with the cutting board;

FIG. 12 is a top, perspective view of another embodiment of the scraper;

FIG. 13 is a partial, top, perspective view illustrating connection of a cutting element to the cutting board via a retainer;

FIG. 14 is a partial, top, perspective view illustrating an alternate embodiment of the retainer;

FIG. 15 is a partial, side, perspective view of the retainer seen in FIG. 14;

FIG. 16 is a partial, top, perspective view illustrating an alternate embodiment of the retainer;

FIGS. 17-20 are side views illustrating various embodiments of blades for use with the cutting element;

FIG. 21 is a side, perspective view of an alternate embodiment of the cutting element;

FIG. 22 is a top view of an alternate embodiment of the cutting element;

FIG. 23 is a top view of an alternate embodiment of the cutting element;

FIG. 24 is a side view of an alternate embodiment of the cutting element;

FIG. 25 is a top, perspective view of a kit in accordance with one aspect of the present disclosure;

FIG. 26 is a bottom, perspective view of one embodiment of the cutting board;

FIG. 27 is a bottom, perspective view of another embodiment of the cutting board;

FIG. 28 is a side, perspective view of another embodiment of the cutting board;

FIG. 29 is a side, perspective view of one embodiment of a tray for use with the cutting board shown in a collapsed configuration;

FIG. 30 is a side view of the tray seen in FIG. 29 shown in an expanded configuration;

FIG. 31 is a bottom, perspective view of one embodiment of the cutting board including a series of expandable legs; and

FIG. 32 is a bottom, perspective view of another embodiment of the cutting board including a series of foldable legs.

### DETAILED DESCRIPTION

The present disclosure describes a cutting board that includes one or more detachable modular accessories, such as, for example, one or more storage trays or bowls, a grater, a peeler, a strainer, etc. The cutting board and the accessories include corresponding attachment structures, such as one or more magnets, to facilitate connection and disconnection of the accessories to a body of the cutting board. In certain embodiments, the cutting board may also include a cutting element (e.g., a knife, chopper, etc.) that is connected to the cutting board in a manner that allows for movement of the cutting element in one or more degrees of freedom. For example, in certain embodiments, the cutting element may be connected to the cutting board to not only allow for the cutting/chopping of items, but for a sweeping motion of the cutting element to move the items across the cutting board.

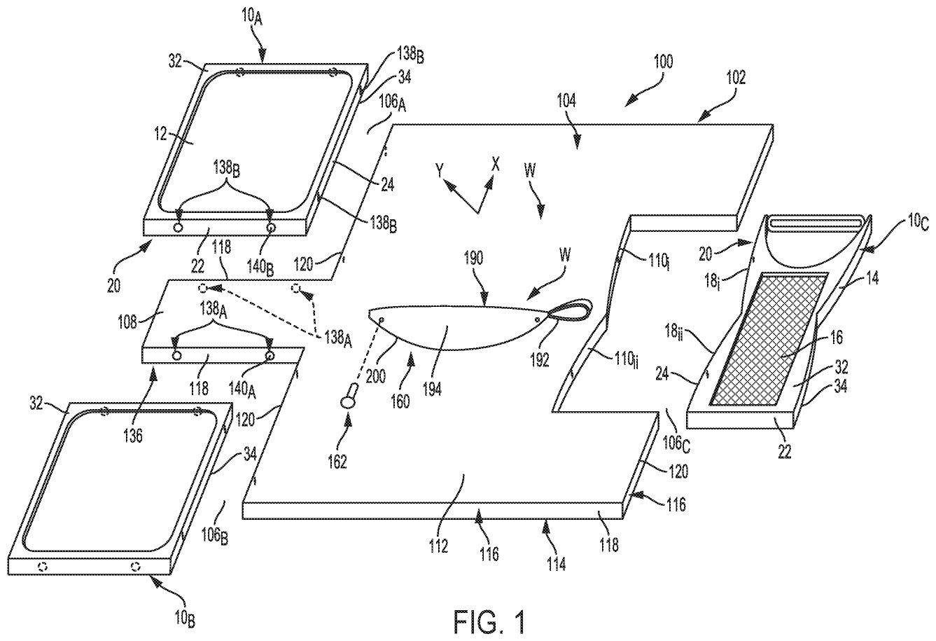

FIG. 1 illustrates one embodiment of the presently disclosed cutting board, which is identified by the reference character 100. The cutting board 100 may include (e.g., may be formed from) any suitable material, such as, for example, wood (e.g., teak, walnut, acacia, bamboo), high-density polyethylene (HDPE), acrylonitrile butadiene styrene (ABS), silicone, etc., and may define any suitable dimensions. For example, the cutting board 100 may define a working area W within the range of approximately 25 in² to approximately 600 in², and a height (thickness) within the range of approximately 0.2″ to approximately 5″, which may be either fixed or variable (e.g., via reconfigurable supports, as discussed below). It should be appreciated, however, that implementations of the cutting board 100 having larger or smaller working areas and/or greater or lesser heights would also be within the scope of the present disclosure. In various implementations, it is envisioned that the cutting board 100 may be rigid in construction, or flexible (e.g., to facilitate folding/bending of the cutting board 100).

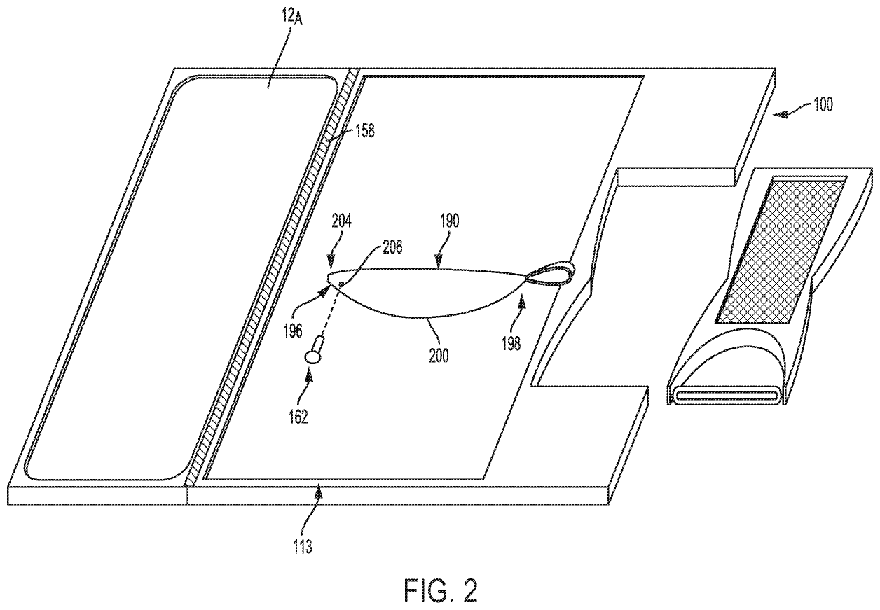

The cutting board 100 includes a body 102, and one or more discrete, modular accessories 10 that are connectable to, and disconnectable from, the body 102. In the particular embodiment illustrated in FIG. 1, for example, the cutting board 100 includes first and second accessories 10_{A}, 10_{B} that are configured as trays 12, and a third accessory 10_{C} that is configured as a peeler 14 with an integral grater/strainer 16. It should be appreciated that in alternate implementations of the disclosure, the number, location, and/or configuration of the accessories 10 may be varied. For example, the cutting board 100 may include a single tray 12A with a larger storage capacity, as seen in FIG. 2, for example. Although illustrated as including a generally planar bottom surface, in alternate implementations, one or more of the trays 12 may include an arcuate inner surface such that the trays 12 are generally configured as bowls.

The cutting board 100 includes a main body portion 104 defining one or more recesses (cutouts) 106 (FIG. 1) that are configured to receive the accessories 10, and a handle 108 that extends from the main body portion 104. More specifically, in the particular embodiment seen in FIG. 1, the cutting board 100 includes three recesses 106A-c that are configured and dimensioned to receive the accessories 10_{A-C}, respectively. The recesses 106 may be generally rectilinear or non-rectilinear (irregular) in configuration. For example, in the embodiment of the cutting board 100 seen in FIG. 1, the recesses 106A, 106E that receive the accessories 10_{A}, 10_{B} are generally rectilinear in configuration, whereas the recess 106_{C} that receives the accessory 10_{C} is non-rectilinear in configuration. More specifically, the recess 106_{C} defines a pair of arcuate segments 110ᵢ, 110ᵢᵢ that are configured and dimensioned in correspondence with arcuate segments 18ᵢ, 18ᵢᵢ defined by the accessory 10_{C}.

The handle 108 allows for movement of the cutting board 100 and also promotes stability during use by providing a tactile surface for the user to grasp. Although generally shown as extending from an end of the main body portion 104 so as to separate the accessories 10_{A}, 10_{B} throughout the figures, the particular position, orientation, and configuration of the handle 108 may be varied in alternate implementations. For example, the handle 108 may extend laterally from a side of the cutting board 100, or may include ergonomic contours (not shown) corresponding to placement of the user's fingers. Implementations devoid of the handle 108 are also within the scope of the present disclosure, as seen in FIG. 2.

The cutting board 100 defines a top (cutting) surface 112, a bottom surface 114, and a plurality of transverse surfaces 116 (i.e., sidewalls 118 and endwalls 120) that define the perimeter of the main body portion 104 and connect the respective top and bottom surfaces 112, 114. It is envisioned that the top surface 112 may be either uniform (FIG. 1) or non-uniform (FIG. 2) in configuration. For example, as shown in FIG. 1, the top surface 112 may be formed from a single piece of continuous material. Alternatively, as shown in FIG. 2, the top surface 112 may include a collection area 113, (e.g., one or more grooves or moats) to collect fluids such as water, juice, blood, etc.

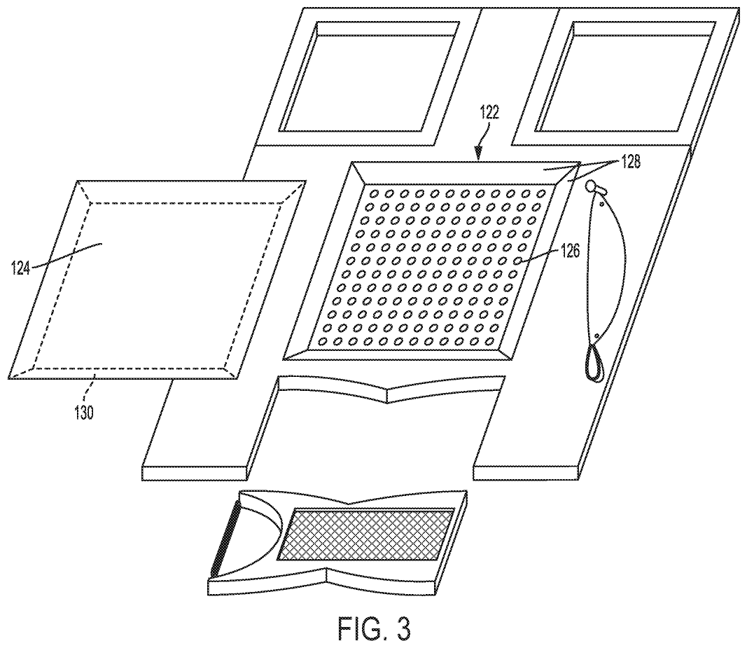

FIG. 3 illustrates an alternate embodiment in which the top surface 112 of the cutting board 100 defines a recess 122 that is configured and dimensioned to removably receive one or more panels 124 to expose an integral screen/strainer 126. In the illustrated embodiment, the recess 122 is defined by beveled walls 128 configured in correspondence with beveled walls 130 included on the panel(s) 124 such that a top surface of the panel(s) 124 is coplanar (flush) with the top (cutting) surface 112 when the panel(s) 124 are positioned in the recess 122. While the beveled walls 128 are shown as being angled inwardly (i.e., towards the screen/strainer 126) and the beveled walls 130 are shown as being angled outwardly (i.e., away from the screen/strainer 126, the configurations of the beveled walls 128, 130 may be reversed (i.e., such that the beveled walls 128 are angled outwardly and the beveled walls 130 are angled inwardly). Depending upon manufacturing tolerances, it is envisioned that the beveled walls 128, 130 may engage one another so as to minimize, or completely eliminate, any space or gapping between the panel(s) 124 and the recess 122 to reduce the likelihood that particles (of food) or liquid may become positioned between the panel(s) 124 and the recess 122 and thereby promote cleanliness of the cutting board 100 during use and storage.

During use, the panel(s) 124 may be removed to expose the screen/strainer 126 (e.g., to wash items prior to cutting). Additionally, or alternatively, the panel(s) 124 may be interchanged when transitioning between uses. For example, one panel 124 may be used in connection with raw meat(s), whereas another panel 124 may be used in connection with vegetables, herbs, fruits, etc., to reduce the likelihood of contamination. It is further envisioned that the panels 124 may be removed, discarded, and replaced as signs of use begin to show (e.g., cut marks, stains, etc.).

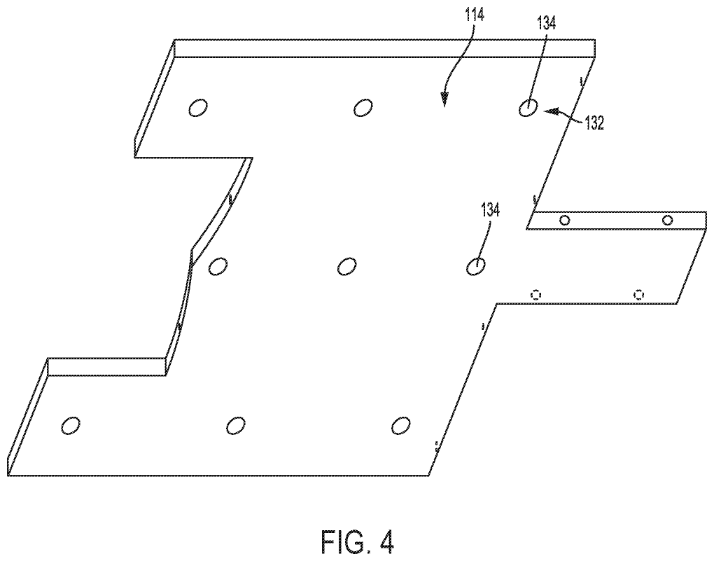

To promote stability, it is envisioned that the bottom surface 114 of the cutting board 100 may include texturing 132 (FIG. 4) so as to limit unintentional movement of the cutting board 100 during use. The texturing 132 may include (e.g., may be formed from) the same material as the bottom surface 114, or may include (e.g., may be formed from) a different material. For example, the texturing 132 may include a series of irregularities 134 (e.g., projections, feet, nubs, bumps, etc.) formed from a material softer than that used in the fabrication of the bottom surface 114 and/or from a material that offers a higher coefficient of frication.

With reference again to FIG. 1, the body 102 of the cutting board 100 and the accessories 10 are configured and adapted for releasable connection via corresponding attachment structures 136, 20. The attachment structures 136, 20 may be any members, structures, or mechanisms suitable for releasably connecting the accessories 10 to the body 102 of the cutting board 100 (e.g., magnets, screws, nuts and bolts, locking pins, cotter pins, snap locks, hinges, a ball and socket, clips, hooks and loops, bristle blocks), various implementations of which are discussed below, and may be either static or dynamic (e.g., spring loaded or tensioned).

In the embodiment seen in FIG. 1, connection and disconnection of the accessories 10 is facilitated by the inclusion of one or more magnets 138 (e.g., neodymium magnets). More specifically, one or more magnets 138A are secured to the perimeter of the body 102 (e.g., to the transverse surfaces 116), and one or more magnets 138E are secured to the perimeters of the accessories 10 in corresponding locations (i.e., to vertical sidewalls 22 and endwalls 24 of the accessories 10). It is envisioned that the magnets 138A, 138E may be recessed into the body 102 and the accessories 10, respectively, such that outer surfaces 140A, 140E of the magnets 138A, 138E are coplanar (flush) with the perimeters of the body 102 and the accessories 10.

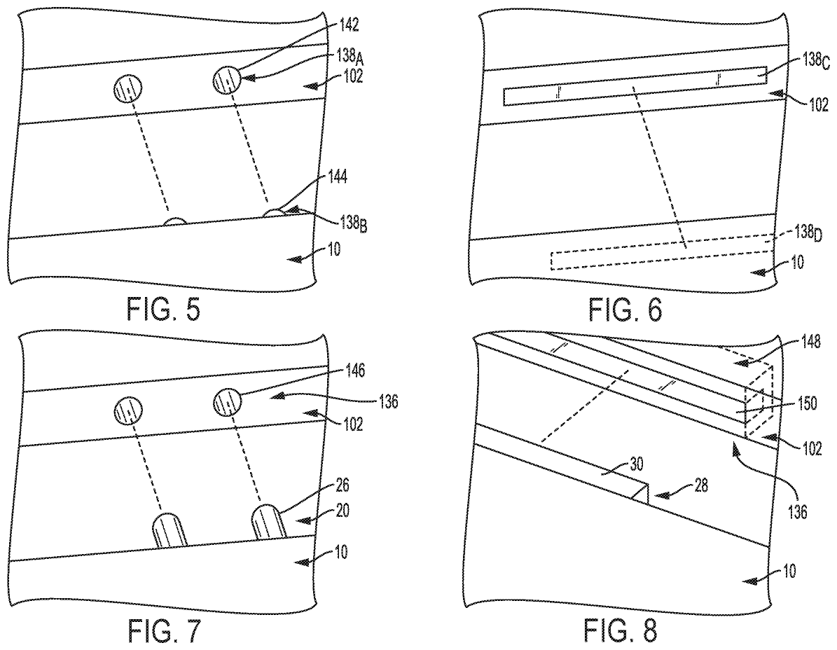

It should be appreciated that the particular number, size, type, and location of the magnets 138A, 138E may be varied in alternate embodiments of the disclosure. For example, in the embodiment seen in FIG. 1, the magnets 138 are shown as being generally planar in configuration. FIG. 5, however, illustrates an embodiment in which the magnets 138 include arcuate configurations. More specifically, the magnets 138A may be configured as concave detents 142, and the magnets 138E may be configured as convex projections 144 that are positionable within the detents 142, or vice versa (i.e., such that the magnets 138A provided on the body 102 are concave in configuration and the magnets 138E provided on the accessories 10 are convex in configuration).

FIG. 6 illustrates another embodiment in which the individual magnets 138A, 138E seen in FIGS. 1 and 5 are replaced by single, longitudinal magnets 138_{C}, 138_{D} included on the body 102 of the cutting board 100 and the accessories 10, respectively.

To protect the magnets 138 and increase their usable life, it is envisioned that the magnets 138 may include a protective cover or coating (e.g., made from a waterproof material).

FIG. 7 illustrates another embodiment in which the attachment structures 136, 20 include corresponding apertures 146 and pins 26. The pins 26 may extend outwardly from the accessories 10 for positioning within the apertures 146 formed in the body 102 of the cutting board 100, or vice versa (i.e., such that the body 102 of the cutting board 100 includes the pins 26 and the accessories 10 include the apertures 146).

FIG. 8 illustrates another embodiment in which the attachment structures 136, 20 include a key and keyway configuration. For example, the attachment structure 136 included on the body 102 of the cutting board 100 may include a keyway 148 configured as a channel 150 that is configured and dimensioned to receive a key 28 provided on the accessories 10 configured as a rib 30, or vice versa (i.e., such that the body 102 of the cutting board 100 includes the key 28 and the accessories 10 include the keyway 148).

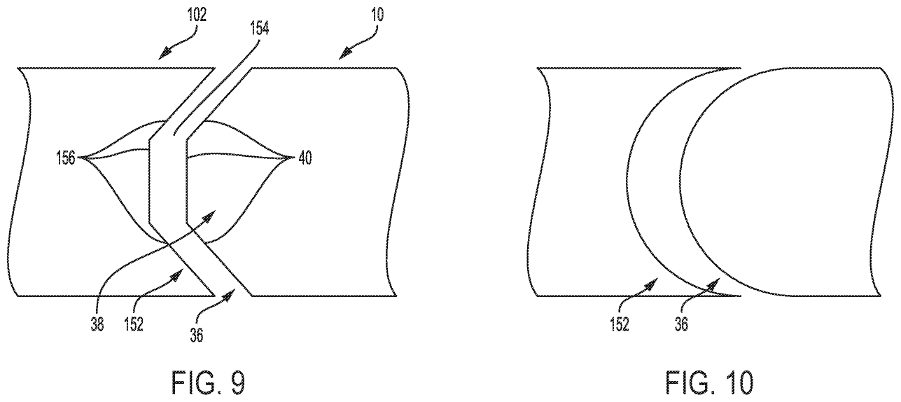

With reference again to FIG. 1, it is envisioned that the perimeters defined by the body 102 of the cutting board 100 and the accessories 10 may be generally planar. For example, as shown in connection with the trays 12, it is envisioned that the sidewalls 118 and the endwalls 120 defined by the body 102 may intersect the respective top and bottom surfaces 112, 114 in orthogonal relation, and that the sidewalls 22 and the endwalls 24 defined by the accessories 10 may intersect respective top and bottom surfaces 32, 34 in orthogonal relation. Alternatively, as seen in FIG. 9, it is envisioned that the perimeters defined by the body 102 of the cutting board 100 and the accessories 10 may be non-planar in configuration so as to define corresponding engagement portions 152, 36, respectively. For example, the engagement portion 152 defined by the body 102 of the cutting board 100 may include a groove 154 that is configured and dimensioned to receive a tongue 38 extending from the accessories 10 such that the engagement portion 152 is generally concave in configuration and the engagement portion 36 is generally convex in configuration.

To further facilitate connection of the accessories 10 to the body 102, and to promote stability and the weight-bearing capabilities of the accessories 10, as shown in FIG. 9, the engagement portions 152, 36 may include corresponding beveled surfaces 156, 40. Upon connection of the accessories 10 to the body 102 of the cutting board 100, the beveled surfaces 156 contact the beveled surfaces 40 in mating engagement. Depending upon manufacturing tolerances, it is envisioned that the beveled surfaces 156, 40 may engage one another so as to minimize, or completely eliminate, any space or gapping between the accessories 10 and the body 102 to reduce the likelihood that particles (of food) or liquid may become positioned between the body 102 and the accessories 10 and thereby promote cleanliness of the cutting board 100 during use and storage. To further promote cleanliness, it is envisioned that the body 102 and/or the accessories 10 may include a protective cover 158 (FIG. 2), such as a seal, gasket, or the like, to further reduce the likelihood that particles or liquid may come into contact with the perimeters of the body 102 and/or the accessories 10.

In an alternate embodiment, seen in FIG. 10, the engagement portions 152, 36 may be devoid of the beveled surfaces 156, 40 (FIG. 9), respectively, such that the engagement portions 152, 36 include smooth, generally arcuate cross-sectional configurations.

With reference again to FIG. 1, the cutting board 100 may further include a cutting element 160, and a retainer 162 that connects the cutting element 160 to the main body portion 104. The retainer 162 may be any member or mechanism suitable for the intended purpose of releasably or fixedly connecting the cutting element 160 to the main body portion 104 such that the cutting element 160 is movable in relation to the cutting surface 112, various examples of which are described below. By securing the cutting element 160 to the cutting board 100 via the retainer 162, ergonomics can be improved and movement of the cutting element 160 can be restricted to reduce user error and, thus, increase safety during use. For example, by restricting motion of the cutting element 160 in the vertical and horizontal directions, the user may be less like to accidentally cut himself/herself. Connecting the cutting element 160 to the cutting board 100 via the retainer 162 may also ensure that the cutting edge of the cutting element 160 is always facing the cutting surface 112 to further protect the user, and guards against mishandling (e.g., dropping) of the cutting element 160 to further reduce the likelihood of injury during use. To further maintain the cutting orientation of the cutting element 160 (i.e., such that the cutting edge faces the cutting surface 112), the cutting board 110 may include a holder, guard, or other such structure upon which the cutting element 160 can rest. For example, the cutting surface 112 may include an integral groove configured to receive the cutting edge when the cutting element 160 is idle.

As can be appreciated through reference to FIG. 1, in certain implementations, it is also envisioned that the cutting element 160, the cutting board 100, and the retainer 162 may be configured and dimensioned such that a cutting edge of the cutting element 160 is not extendable beyond the cutting surface 112 so as to prevent inadvertent exposure of the cutting edge. For example, horizontal movement of the cutting element 160 may be restricted and/or the cutting element 160 may be dimensioned such that the length of the cutting element 160 is less than the horizontal distances between the retainer 162 and the ends of the cutting surface 112.

It is envisioned that the retainer 162 may connect the cutting element 160 to the main body portion 104 for movement in a single degree of freedom only (i.e., such that the cutting element 160 is movable along a vertical Y axis that is orthogonal in relation to the cutting surface 112). Alternatively, however, it is envisioned that the retainer 162 may connect the cutting element 160 to the main body portion 104 for movement in multiple degrees of freedom. For example, the cutting element 160 may also be movable along a horizontal axis X that is parallel in relation to the cutting surface 112. As the cutting element 160 is moved vertically, the cutting element 160 can be used to cut, slice, etc. Thereafter, the cutting element 160 can be moved horizontally across the cutting surface 112 (e.g., to move cut items into one of the trays 12). To increase the usable range of the cutting element 160, it is envisioned that the retainer 162 may be configured to permit 180° of movement along the Y-axis and 360° of movement along the X-axis. In those implementations in which the cutting element 160 is movable 180° along the Y-axis, it is envisioned that the cutting element 160 may include opposing cutting edges (e.g., a top, serrated cutting edge and a bottom, non-serrated cutting edge) to permit various types of cutting without exchange of the cutting element 160.

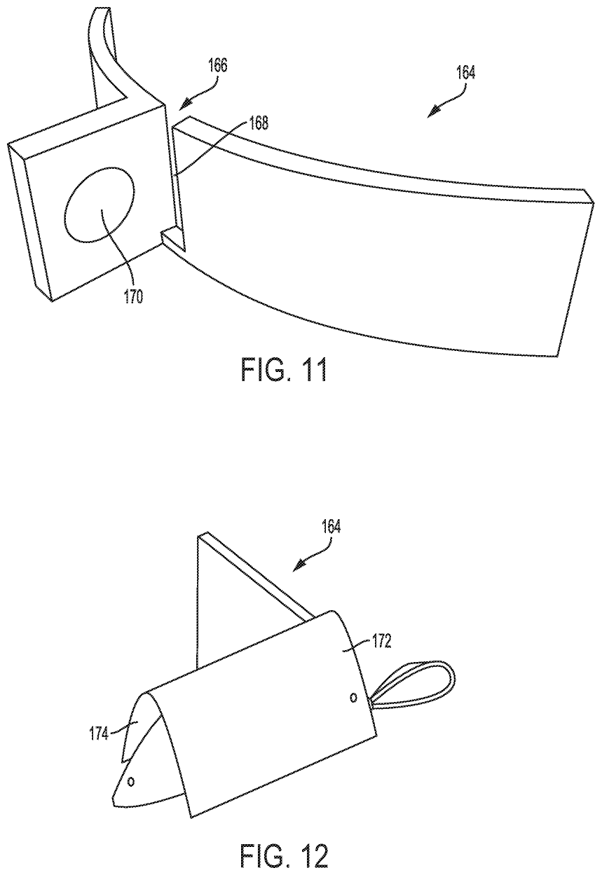

To assist in the movement of items across the cutting surface 112, a scraper 164 (FIG. 11) may be provided. The scraper 164 is connectable to the cutting element 160 to capture and sweep items (e.g., food or the like) across the cutting surface 112 (FIG. 1) (e.g., into the tray(s) 12), which are secured in place via the attachment structures 136, 20 to limit (or prevent) inadvertent disconnection of the trays 12 as they are filled. In the embodiment illustrated in FIG. 11, the scraper 164 defines an opening 166 (e.g., a slit 168) that is configured and dimensioned to receive the cutting element 160 (FIG. 1) from above. To connect the scraper 164 to the cutting element 160, it is envisioned that the scraper 164 may include a magnet 170. In an alternate configuration, it is envisioned that the scraper 164 may include a clip 172 (FIG. 12) defining an opening 174 such that the clip 172 can be attached to the cutting element 160 (FIG. 1) from above.

FIG. 13 illustrates one embodiment of the presently disclosed retainer 162 that includes a pin 176 configured and dimensioned for receipt within an opening 178 formed in the body 102 of the cutting board 100. It is envisioned that the pin 176 may be either rotatably (e.g., threadably) positioned within the opening 178 such that the cutting element 160 is horizontally movable across the cutting surface 112 (along the X-axis), or alternatively, that the pin 176 may be fixedly positioned within the opening 178 to prevent horizontal movement of the cutting element 160.

To connect the cutting element 160 to the pin 176, the retainer 162 may include a fastener 180 (e.g., a rivet, screw, dowel, etc.) that extends through the pin 176 and the cutting element 160. In such implementations, it is envisioned that the fastener 180 may be removable from the pin 176 and the cutting element 160 to permit interchangeability of the cutting element 160 (discussed below). The fastener 180 extends through the cutting element 160 such that the cutting element 160 is pivotable in relation to the pin 176 and the body 102 of the cutting board 100 to allow for vertical movement of the cutting element 160 (along the Y-axis) during cutting, chopping, etc.

FIGS. 14-16 illustrate alternate embodiments of the retainer, which are respectively identified by the reference characters 162A, 162_{B}. In contrast to the retainer 162, the retainers 162A, 162_{E} allow for movement in an additional degree of freedom along an axis Z that is transverse in relation to the axes X, Y. More specifically, the retainer 162A includes a body portion 182 defining a slit 184 that is configured and dimensioned to receive the cutting element 160. To connect the cutting element to the retainer 162, the retainer 162 may include one or more magnets 186 (e.g., positioned on opposing sides of the cutting element 160). The retainer 162_{E} is devoid of the body portion 182 to allow for even more freedom of movement, and includes a magnetic surface 188 that is embedded in the cutting surface 112.

With reference to FIGS. 1, 2, and 17-24, the cutting element 160 will be discussed. The cutting element 160 is configured as a knife 190 (FIGS. 1, 2) including a handle 192 and a blade 194. The blade 194 includes opposing end portions 196, 198, and a cutting edge 200. Depending upon the particular intended use of the cutting element 160, it is envisioned that the blade 194 may define an overall length substantially within the range of approximately 2″ to approximately 12″ and an overall height substantially within the range of approximately 1″ to approximately 3″. A blade 194 including dimensions falling outside these ranges, however, would not be beyond the scope of the present disclosure.

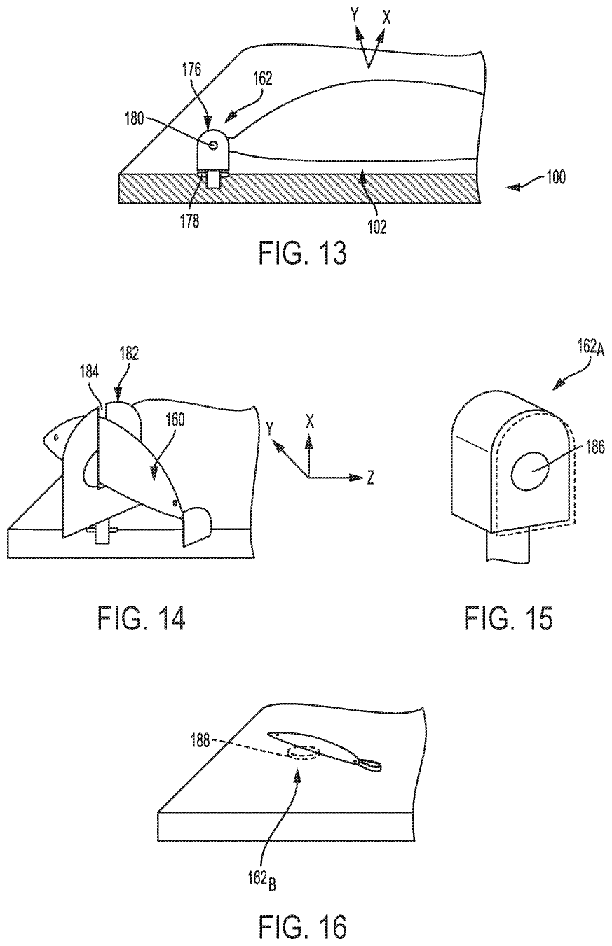

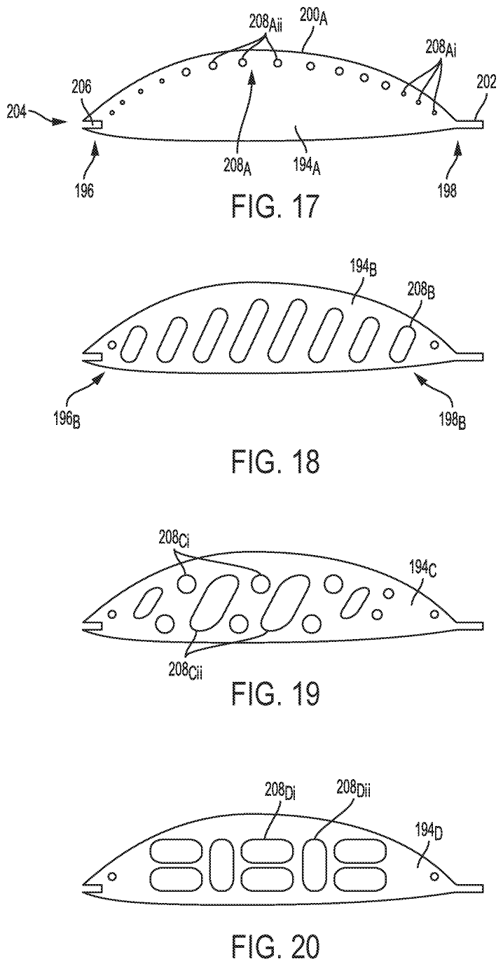

The end portions 196, 198 are dimensioned to facilitate engagement with the retainer 162 and the handle 192, respectively, which may be achieved in any suitable manner (e.g., through the use of mechanical connectors, adhesives, etc.). For example, the end portion 196 may define a length and a height each substantially within the range of approximately ½″ to approximately 1″, and the end portion 198 may include an extension (tang) 202 (FIG. 17) defining a length substantially within the range of approximately ½″ to approximately 3″. The end portion 196 includes an engagement structure 204 (FIG. 2) that is configured and dimensioned to permit movement of the cutting element 160 in relation to the retainer 162 in the manner discussed above. For example, as shown in FIG. 2, the engagement structure 204 may include an aperture 206 configured as a circular opening, slit, or any other structure capable of securely receiving the fastener 180 (FIG. 13) extending through the retainer 162. For example, the aperture 206 may define a transverse dimension (e.g., a diameter) of approximately 2 mm. To further facilitate engagement with the retainer 162, it is envisioned that the engagement structure 204 may include an elongate profile, as shown in FIG. 17, for example, that extends longitudinally from the end portion 196.

As seen in FIGS. 1 and 2, the blade 194 may include a generally uniform configuration. Alternatively, FIG. 17 illustrates a blade 194_{A} that includes a non-uniform configuration. The blade 194_{A} includes a series of openings 208A extending along a contour of the cutting edge 200A that are each generally circular in configuration (i.e., such that the configuration of each of the openings 208A is identical). Although illustrated as extending completely through the blade 194_{A} in FIG. 17, in alternate implementations, the openings 208A may extend only partially into the blade 194_{A} so as to define reliefs. In the particular embodiment shown in FIG. 17, the openings 208A include a first series of openings 208_{Ai} defining a first transverse dimension (e.g., diameter) and a second series of openings 208_{Aii} defining a second, different transverse dimension (e.g., diameter) spaced inwardly from the first series of openings 208_{Ai}. It is envisioned that the first transverse dimension may be within the range of approximately 1 mm to approximately 5 mm and that the second transverse dimension may be within the range of approximately 2 mm to approximately 10 mm, although openings 208_{Ai}, 208_{Aii} defining transverse dimensions outside these ranges would not be beyond the scope of the present disclosure.

FIG. 18 illustrates an alternate embodiment of the blade identified by the reference character 194_{B} that includes generally elliptical openings 208_{B} that are each oriented at an identical angle in relation to the height of the blade 194_{B}. As seen in FIG. 18, however, the openings 208_{B} vary in dimensions such that the cross-sectional area of the openings 208_{B} decreases towards the end portions 196_{B}, 198_{B}.

FIG. 19 illustrates a blade 194_{C} including a first series of openings 208_{C}, that define a first configuration and a second series of openings 208_{Cii} that define a second, different configuration. For example, as illustrated in FIG. 19, the first series of openings 208_{C}, may be generally circular in configuration, and the second series of openings 208_{Cii} may be generally elliptical in configuration. Although shown as extending transversely (i.e., at an angle) in relation to the height of the blade 194_{C}, in alternate implementations, the openings 208_{Cii} and the height of the blade 194_{C} may extend along parallel axes.

FIG. 20 illustrates another embodiment of the blade identified by the reference character 194_{D}, in which the first series of openings 208_{D}, and the second series of openings 208_{Dii} define identical configurations, but are positioned in different orientations. For example, as illustrated in FIG. 20, each of the openings 208_{Di}, 208_{Dii} is generally elliptical in configuration; however, whereas the openings 208_{Di} are oriented so as to extend transversely (e.g., orthogonally) in relation to the height of the blade 194_{D}, the openings 208_{Dii} extend along axes that are parallel in relation to the height of the blade 194_{D}.

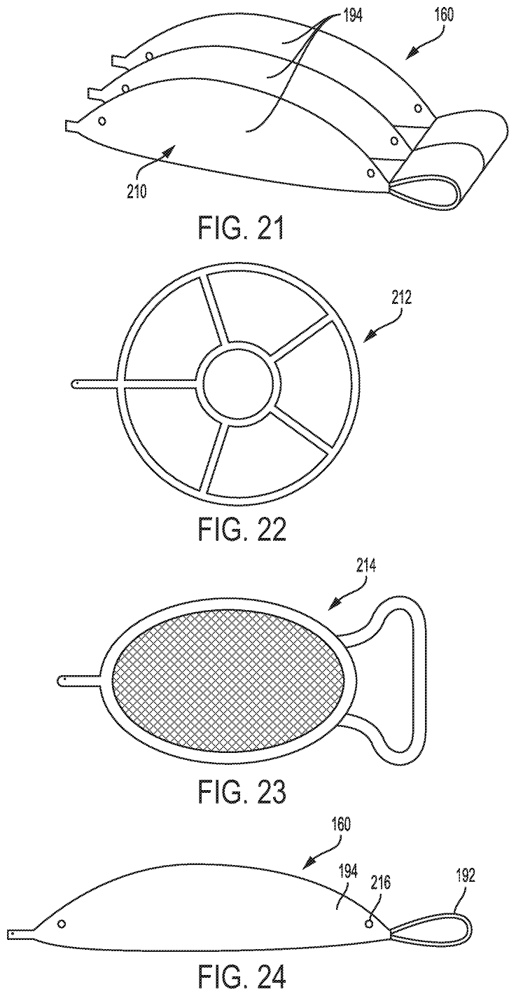

In alternate embodiments of the disclosure, the configuration of the cutting element 160 may be varied from the knife 190 seen in FIGS. 1 and 2. For example, the cutting element 160 may be configured as a multi-blade knife 210 (FIG. 21) including a plurality of blades 194, a mesh cutter 212 (FIG. 22), or a slicer 214 (FIG. 23). FIG. 24 illustrates another embodiment of the cutting element 160 in which the handle 192 is connected to the blade 194 by a pivot member 216 to allow for relative movement between the handle 192 and the blade 194.

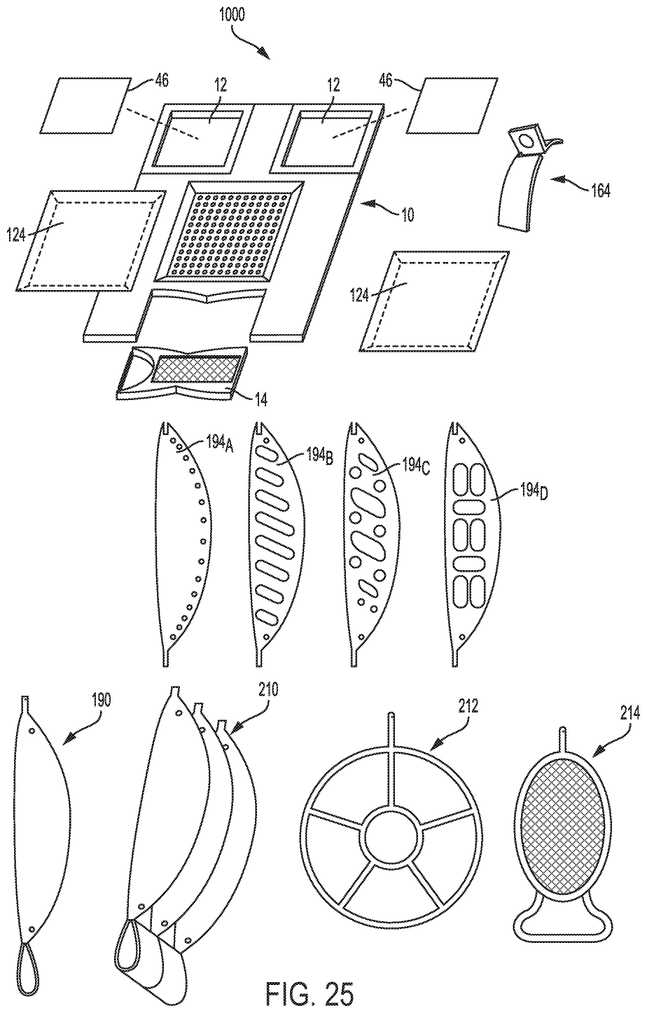

In those embodiments of the retainer 162 (FIG. 1) allowing for releasable connection and disconnection of the cutting element 160, it is envisioned that the cutting element 160 may be selectively interchanged by the user during use. For example, the user may initially connect the knife 190 (FIGS. 1, 2) to the cutting board 100 and may thereafter exchange the knife 190 for the mesh cutter 212 (FIG. 22) or the slicer 214 (FIG. 23). It is also envisioned that the various embodiments of the blade 194 may be used interchangeably. For example, the user may initially connect the blade 194_{A} (FIG. 17) to the handle 192 (FIGS. 1, 2) of the cutting element 160, and may then exchange the blade 194_{A} for the blade 194_{B} (FIG. 18), the blade 194_{C} (FIG. 19), or the blade 194_{D} (FIG. 20). In such embodiments, the cutting board 100, the accessories 10, the knife 190, the blades 194_{A}-D, and the various embodiments of the cutting element 160 may be provided as part of a kit 1000 (FIG. 25), which may also include one or more of the aforedescribed panels 124 and the scraper 164.

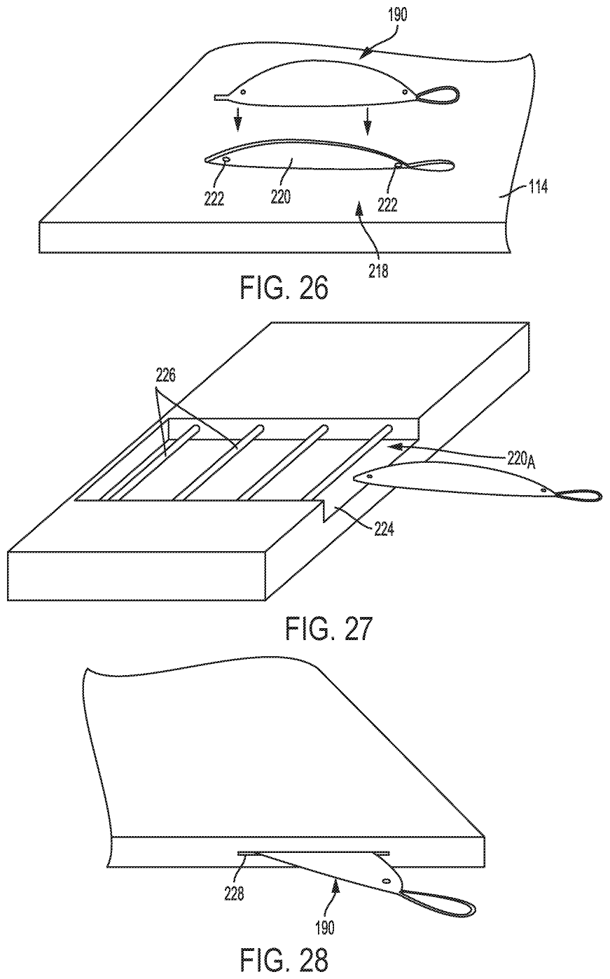

To facilitate storage of the cutting board 100 and organization of the various accessories (e.g., the knife 190, the blade 194_{A}, etc.), the cutting board 100 may include one or more integral storage compartments 218 (FIG. 26). For example, the cutting board 100 may include a cavity 220 formed in the bottom surface 114 to permit drainage after washing of the knife 190. As seen in FIG. 26, the cavity 220 may be configured in correspondence with the knife 190 (and/or the blades 194_{A-D} seen in FIGS. 17-20). To protect against inadvertent removal of the knife 190 from the cavity 220, the cavity 220 may be provided with one or more retention members, such as magnets 222.

FIG. 27 illustrates an alternate embodiment including a cavity 220A that is generally configured as a storage chamber 224. To protect against inadvertent removal of the knife 190 from the storage chamber 224, the storage chamber 224 may include a series of guards 226 formed from any suitable material, such as wood (e.g., teak, walnut, acacia, bamboo), high-density polyethylene (HDPE), acrylonitrile butadiene styrene (ABS), silicone, stainless steel, etc.

FIG. 28 illustrates another embodiment in which the cutting board includes an integral slot 228 that is configured and dimensioned to accommodate the knife 190, the blades 194_{A-D} (FIGS. 17-20), etc. It is envisioned that the slot 228 may be provided in addition to, or instead of, the storage compartment 218 (e.g., the cavity 220 seen in FIG. 26). For example, in those embodiments including both the cavity 220 and the slot 228, the knife 190 may be stored in the slot 228, and one or more of the blades 194_{A-D} (FIGS. 17-20) may be stored in the cavity 220.

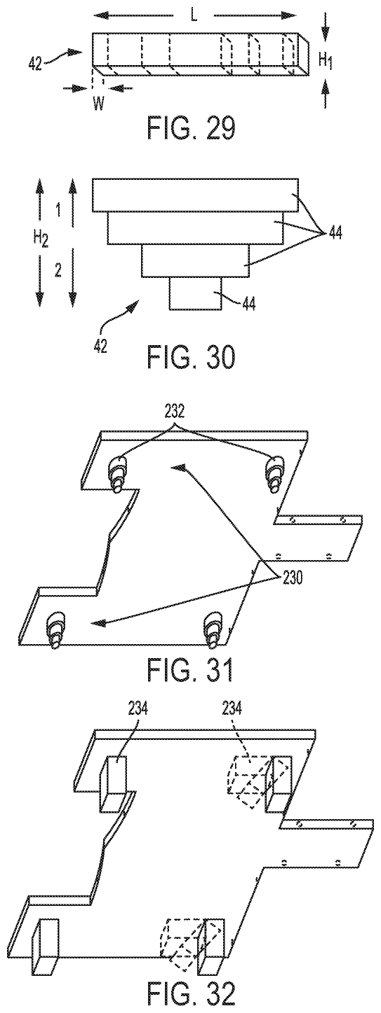

With reference now to FIGS. 29 and 30, an alternate embodiment of the tray is illustrated, which is identified by the reference character 42. The tray 42 includes a series of nested members 44 that are configured, dimensioned, and connected to permit movement of the tray 42 between a collapsed configuration (FIG. 29) and an expanded configuration (FIG. 30). In the collapsed configuration, the tray 42 defines an overall length L, an overall width W, and an overall height H₁, and, thus, a first volume. In the expanded configuration, however, the tray 42 defines an overall height H₂ greater than the height H₁, and, thus, a second, greater volume. To move the tray 42 between the collapsed and expanded configurations, the user can apply an axial force to the tray 42 in the directions indicated by arrows 1 and 2.

To permit use of the tray(s) 42 in the expanded configuration, it is envisioned that the cutting board 100 may be elevated through the use of one more reconfigurable supports 230. For example, the cutting board 100 may include a plurality of telescoping, extendable legs 232 (FIG. 31) or a plurality of foldable, collapsible legs 234 (FIG. 32).

To preserve food after use of the cutting board 100, it is envisioned that the trays described herein (e.g., the trays 12 seen in FIG. 1 or the tray 42 seen in FIGS. 29, 30) may include a removable lid 46 (FIG. 25).

Persons skilled in the art will understand that the various embodiments and implementations of the disclosure described herein and shown in the accompanying figures constitute non-limiting examples, and that additional components and features may be added to any of the embodiments and implementations discussed hereinabove without departing from the scope of the present disclosure. For example, the various components of the cutting board 100 may include a fluid-resistant or waterproof coating (e.g., polyurethane, chrome plating, etc.). Additionally, persons skilled in the art will understand that the elements and features shown or described in connection with one embodiment or implementation may be combined with those of another embodiment or implementation without departing from the scope of the present disclosure, and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative implementations that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “upward,” “downward,” “inward,” “outward,” etc., should be understood to describe a relative relationship between structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately” and “generally” should be understood to encompass variations on the order of 25%, or to allow for manufacturing tolerances and/or deviations in design.

Each and every claim is incorporated as further disclosure into the specification, and represents embodiments and implementations of the present disclosure. Also, the phrases “at least one of A, B, and C” and “A and/or B and/or C” should each be interpreted to include only A, only B, only C, or any combination of A, B, and C.

What is claimed is:

1. A cutting board, comprising:
a body including a first attachment structure; and
at least one accessory configured for releasable connection to the body, the at least one accessory including a second attachment structure positioned in correspondence with the first attachment structure to facilitate connection and disconnection of the at least one accessory and the body.

2. The cutting board of claim 1, wherein the first attachment structure is associated with a perimeter of the body and the second attachment structure is associated with a perimeter of the at least one accessory.

3. The cutting board of claim 2, wherein the first attachment structure is configured and dimensioned for positioning within the second attachment structure.

4. The cutting board of claim 1, wherein the first and second attachment structures include magnets.

5. The cutting board of claim 4, wherein the magnets are secured to perimeters of the body and the at least one accessory.

6. The cutting board of claim 5, wherein the magnets are embedded within the perimeters of the body and the at least one accessory.

7. The cutting board of claim 4, wherein the at least one accessory includes a first accessory and a second accessory, the first and second accessories being independently connectable to the body and independently disconnectable from the body.

8. The cutting board of claim 7, wherein the body defines a main body portion and a handle extending from the main body portion.

9. The cutting board of claim 8, wherein the handle extends from the main body portion such that the handle is positionable between the first and second accessories.

10. The cutting board of claim 1, wherein the body and the at least one accessory include corresponding engagement portions defining beveled surfaces configured and dimensioned for mating engagement.

11. The cutting board of claim 10, wherein the engagement portions include corresponding concave and convex configurations.

12. The cutting board of claim 1, further including a cutting element connected to the body.

13. The cutting board of claim 12, wherein the cutting element is connected to the body such that the cutting element is movable in at least one degree of freedom.

14. The cutting board of claim 13, wherein the cutting element is connected to the body such that the cutting element is movable in multiple degrees of freedom, the cutting element being movable along a first axis extending in generally orthogonal relation to a top surface of the cutting board and along a second axis extending in generally parallel relation to the top surface of the cutting board.

15. The cutting board of claim 1, wherein the body includes a removable panel.

16. The cutting board of claim 15, wherein the body defines a recess configured and dimensioned to receive the panel such that the panel is coplanar with a top surface of the body.

17. A cutting board comprising at least one magnetically connectable accessory.

18. The cutting board of claim 17, wherein the at least one magnetically connectable accessory includes discrete first and second accessories.

19. The cutting board of claim 18, wherein the cutting board defines a handle extending between the first and second accessories when the first and second accessories are connected to the cutting board.

20. A method of manufacturing a cutting board including at least one removable accessory, comprising:
forming at least one recess in a body of the cutting board configured and dimensioned to receive the at least one accessory;
connecting a first magnet to the body of the cutting board such that the first magnet is oriented in transverse relation to a cutting surface of the cutting board; and
connecting a second magnet to the at least one accessory such that the first and second magnets are positioned in correspondence when the at least one accessory is situated within the recess to permit connection and disconnection of the at least one accessory and the body.
